(19) United States
(12) Patent Application Publication
(10) Pub. No.: US 2025/0132633 A1
(43) Pub. Date: Apr. 24, 2025

(54) MOTOR

(71) Applicant: Nidec Corporation, Kyoto (JP)

(72) Inventors: Kanwu SHIRAKAWA, Kyoto (JP); Yuichi NISHIKAWA, Kyoto (JP); Yuki HAMADA, Kyoto (JP); Sora OKUI, Kyoto (JP)

(21) Appl. No.: 18/685,748

(22) PCT Filed: May 18, 2022
(86) PCT No.: PCT/JP2022/020670

§ 371 Date: Feb. 22, 2024

(30) Foreign Application Priority Data
Aug. 24, 2021 (JP) 2021-136202

(51) Int. Cl. H02K 5/24; H02K 5/22

(52) U.S. Cl. CPC H02K 5/24; H02K 5/225

(57) ABSTRACT

A motor with a motor body includes a rotor rotatable about a center axis extending in an axial direction and a stator opposing the rotor with a gap interposed therebetween, a housing accommodating the motor body, a cover covering the housing from a first side in the axial direction, a controller including an electronic component and accommodated between the housing and the cover, and a weight fixed to the cover.

### CROSS-REFERENCE TO RELATED APPLICATIONS

This is a U.S. national stage of application No. PCT/JP2022/020670, filed on May 18, 2022, with priority under 35 U.S.C. § 119(a) and 35 U.S.C. § 365(b) being claimed from Japanese Patent Application No. 2021-136202, filed on Aug. 24, 2021, the entire contents of which are hereby incorporated herein by reference.

### 1. FIELD OF THE INVENTION

The present disclosure relates to a motor.

### 2. BACKGROUND

A motor provided with a cover covering a circuit board is known. For example, conventionally, an electric actuator including such a motor and applied to a brake booster device for an automobile, or the like, is known.

The motor as described above may cause noise due to the cover that resonates when a predetermined frequency of vibration generated based on drive of the motor coincides with a natural frequency of the cover.

### SUMMARY

A motor according to an example embodiment of the present disclosure includes a motor body including a rotor rotatable about a center axis extending in an axial direction and a stator opposing the rotor with a gap interposed between the rotor and the stator, a housing accommodating the motor body, a cover covering the housing from a first side in the axial direction, a controller including an electronic component and accommodated between the housing and the cover; and a weight fixed to the cover.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view illustrating a motor according to a first example embodiment of the present invention.

FIG. 2 is a perspective view illustrating the motor of the first example embodiment.

FIG. 3 is a diagram of the motor according to the first example embodiment as viewed from above.

FIG. 4 is a sectional view illustrating a portion of the motor of the first example embodiment.

FIG. 5 is a sectional view illustrating a portion of a motor according to a second example embodiment of the present invention.

FIG. 6 is a sectional view illustrating a portion of a motor according to a third example embodiment.

### DETAILED DESCRIPTION

Each drawing virtually illustrates a center axis J in the motor of each example embodiment described below. The description below refers to an axial direction of the center axis J as simply an “axial direction”. A radial direction about the center axis J is simply referred to as a “radial direction”. A circumferential direction about the center axis J is simply referred to as a “circumferential direction”. Each drawing illustrates a Z-axis that indicates a direction in which the center axis J extends. The description below refers to a first side (+Z side) in the axial direction toward which an arrow of the Z-axis is directed as an “upper side”, and a second side (−Z side) in the axial direction opposite to the first side toward which the arrow of the Z-axis is directed as a “lower side”.

Each drawing illustrates an X-axis that indicates a first direction orthogonal to the axial direction. The description below refers to a direction parallel to the X-axis as a “first direction X”. The first direction X includes a first side (+X side) on which the arrow of the X-axis is directed, the first side being referred to as a “first side in the first direction X”, and a second side (−X side) opposite to the first side in the first direction X on which the arrow of the X-axis is directed, the second side being referred to as a “second side in the first direction X”. Each drawing illustrates a Y-axis that indicates a second direction orthogonal to both the axial direction and the first direction X. The description below refers to a direction parallel to the Y-axis as a “second direction Y”. The second direction Y includes a first side (+Y side) on which the arrow of the Y-axis is directed, the first side being referred to as a “first side in the second direction Y”, and a second side (−Y side) opposite to the first side in the second direction Y on which the arrow of the Y-axis is directed, the second side being referred to as a “second side in the second direction Y”.

Each example embodiment below shows an upper side corresponding to the “first side in the axial direction”, and a lower side corresponding to the “second side in the axial direction”. The upper side and the lower side are simply terms for describing a relative positional relationship of each part, and thus an actual placement relationship and the like may be a placement relationship and the like other than the placement relationship and the like indicated by the terms.

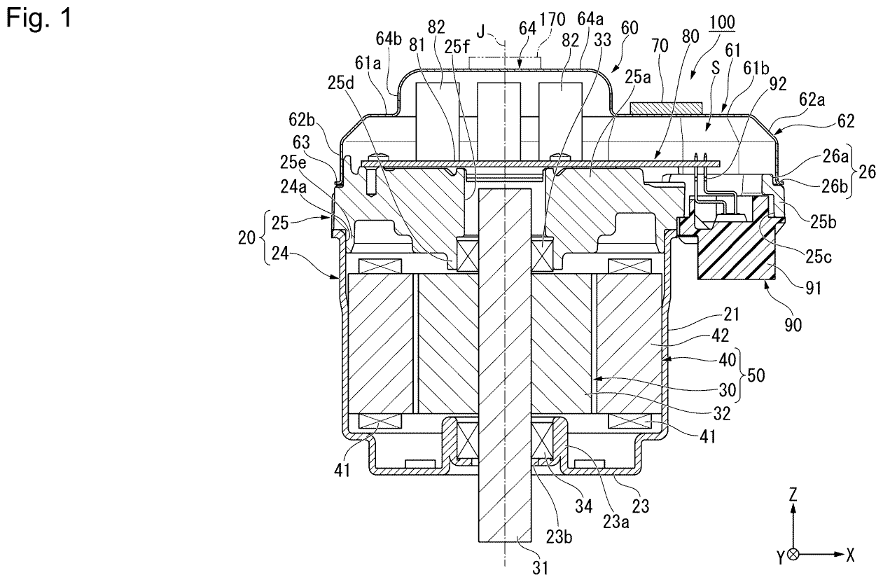

As illustrated in FIG. 1, a motor 100 includes a housing 20, a motor body 50, an upper bearing 33, a lower bearing 34, a cover 60, a controller 80, and a connector 90. The motor body 50 includes a rotor 30 rotatable about a center axis J extending in the axial direction, and a stator 40 facing the rotor 30 with a gap interposed therebetween.

The rotor 30 includes a shaft 31 and a rotor body 32. The shaft 31 has a columnar shape about the center axis J extending in the axial direction. The shaft 31 includes a lower end portion protruding downward of the housing 20 through an output shaft hole 23b described later. The rotor body 32 is fixed to an outer peripheral surface of the shaft 31. Although not illustrated, the rotor body 32 includes a rotor core fixed to the outer peripheral surface of the shaft 31 and a magnet fixed to the rotor core.

The upper bearing 33 and the lower bearing 34 rotatably support the shaft 31 around the center axis J. The lower bearing 34 is held by the housing 20 below the stator 40. The upper bearing 33 is held by the housing 20 above the stator 40.

The stator 40 is located radially outside the rotor 30. The stator 40 has an annular shape surrounding the rotor 30. The stator 40 includes a plurality of coils 41 and a stator core 42. The stator core 42 has an outer peripheral surface fixed to an inner peripheral surface of the housing 20. The plurality of coils 41 is attached to the stator core 42 with an insulator (not illustrated) interposed therebetween, for example.

The housing 20 accommodates the motor body 50. The housing 20 includes a lower housing 24 that accommodates the rotor 30 and the stator 40, and an upper housing 25 located above the lower housing 24.

The lower housing 24 according to the present example embodiment is a sheet metal member formed by pressing a metal plate member. The lower housing 24 includes a tubular portion 21 extending in the axial direction, a bottom wall part 23 located at a lower end of the tubular portion 21, and an opening part 24a open upward. The tubular portion 21 according to the present example embodiment has a cylindrical shape about the center axis J. The tubular portion 21 has an inner peripheral surface to which the stator 40 is fixed. The shape of the tubular portion 21 is not limited to a cylindrical shape and may be a polygonal cylindrical shape, for example. The bottom wall part 23 is located below the stator 40. The bottom wall part 23 includes a bearing holder 23a that holds the lower bearing 34, and an output shaft hole 23b that passes through the bottom wall part 23 in the axial direction.

The upper housing 25 is a metal member made of aluminum, for example. The upper housing 25 includes a heat sink part 25a located above the lower housing 24 and a connector holder 25b extending radially outward from the heat sink part 25a.

The heat sink part 25a has an annular shape having a through-hole 25f at a central part in the radial direction. Into the through-hole 25f, an upper end portion of the shaft 31 is inserted. The heat sink part 25a has an upper surface on which the controller 80 is disposed. The controller 80 is thermally connected to the heat sink part 25a through a heat transfer member (not illustrated). The heat sink part 25a dissipates heat transferred from the controller 80 to cool the controller 80. The heat sink part 25a includes a bearing holder 25d in a cylindrical shape open in a lower surface of the heat sink part 25a. The bearing holder 25d internally holds the upper bearing 33. The heat sink part 25a includes a tubular-shaped part 25e protruding downward from the lower surface. The tubular-shaped part 25e is inserted into the opening part 24a facing upward of the lower housing 24 from the upper side. The heat sink part 25a and the lower housing 24 are fixed to each other by bolts (not illustrated).

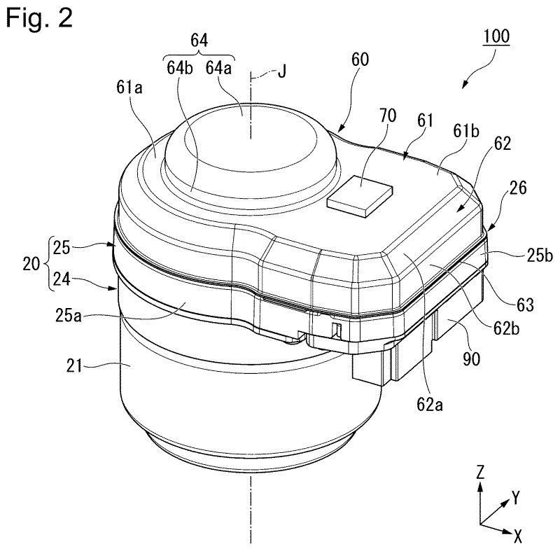

As illustrated in FIGS. 1 and 2, the connector holder 25b protrudes radially outward from the outer peripheral surface of the tubular portion 21 from the heat sink part 25a. The connector holder 25b according to the present example embodiment protrudes from the heat sink part 25a toward the first side (+X side) in the first direction X. The connector holder 25b has a substantially rectangular frame shape when viewed in the axial direction. As illustrated in FIG. 1, the connector holder 25b includes a connector insertion hole 25c passing through the connector holder 25b in the axial direction. Into the connector insertion hole 25c, the connector 90 is inserted from the lower side and held.

The upper housing 25 includes a stepped part 26 located on an outer peripheral surface of the upper housing 25. The stepped part 26 extends along the circumferential direction of the upper housing 25. The stepped part 26 includes a first surface 26a facing radially outward and a second surface 26b facing upward and expanding radially outward from a lower end of the first surface 26a.

The controller 80 is located on an upper surface of the upper housing 25. The controller 80 according to the present example embodiment includes a circuit board 81 extending in a direction intersecting the axial direction, and an electronic component 82 attached to the circuit board 81. The electronic component 82 constitutes a plurality of electronic components 82. The plurality of electronic components 82 according to the present example embodiment is attached to an upper surface of the circuit board 81. The plurality of electronic components 82 includes a capacitor, a transistor constituting an inverter circuit, and the like. Although not illustrated, a coil wire (not illustrated) extending from the stator 40 is electrically connected to the circuit board 81.

The connector 90 is held by the connector holder 25b. The connector 90 protrudes downward from the connector holder 25b. The connector 90 is located at a position protruding toward the first side (+X side) in the first direction X orthogonal to the axial direction with respect to the motor body 50. The connector 90 includes a holder 91 made of resin and a plurality of bus bars 92 held by the holder 91. Each bus bar 92 is electrically connected at one end to the circuit board 81. Each bus bar 92 has the other end exposed in a recess (not illustrated) provided in the connector 90. The recess (not illustrated) provided in the connector 90 is open downward. The bus bar 92 is electrically connected at the other end to an external power supply (not illustrated) or the like connected to the connector 90.

The cover 60 has a container shape that is open downward. The cover 60 according to the present example embodiment is a sheet metal member formed by pressing a metal plate member. The cover 60 is configured to cover the housing 20 from the upper side. The cover 60 according to the present example embodiment is attached to an upper end portion of the upper housing 25. The cover 60 and the housing 20 form an accommodation space S that accommodates the controller 80. That is, the controller 80 is accommodated between the housing 20 and the cover 60.

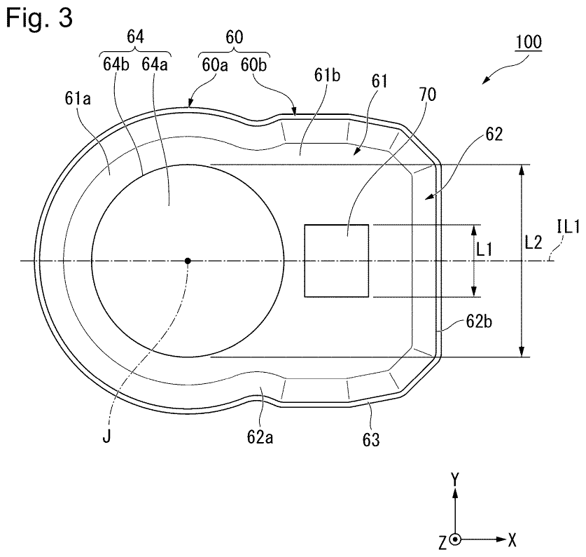

As illustrated in FIG. 3, the cover 60 includes a first part 60a and a second part 60b connected to the first part 60a on the first side (+X side) in the first direction X. The first part 60a has a substantially circular shape about the center axis J when viewed in the axial direction. The second part 60b has a substantially rectangular shape when viewed in the axial direction. The cover 60 includes a top plate portion 61, a tubular portion 62, a flange part 63, and a protruding tubular portion 64.

As illustrated in FIG. 1, the top plate portion 61 is located above the controller 80. The top plate portion 61 has a plate shape with a plate surface facing the axial direction. The top plate portion 61 expands in the radial direction. As illustrated in FIG. 3, the top plate portion 61 includes an arc part 61a provided in the first part 60a and a protruding plate portion 61b provided in the second part 60b. The arc part 61a has an arcuate shape extending in the circumferential direction. The arc part 61a is disposed along the protruding tubular portion 64 radially outside the protruding tubular portion 64.

The protruding plate portion 61b protrudes from the protruding tubular portion 64 toward the first side (+X side) in the first direction X. The protruding plate portion 61b has a substantially rectangular shape when viewed in the axial direction. The protruding plate portion 61b is connected at an end portion on the second side (−X side) in the first direction X to the protruding tubular portion 64 and the arc part 61a. As illustrated in FIG. 1, at least a portion of the protruding plate portion 61b overlaps the connector 90 when viewed in the axial direction. The protruding plate portion 61b according to the present example embodiment includes a part on the first side in the first direction X, the part overlapping the connector 90 when viewed in the axial direction.

As illustrated in FIGS. 1 and 2, the tubular portion 62 protrudes downward from a radially outer peripheral edge part of the top plate portion 61. The tubular portion 62 is fitted to the stepped part 26 from radially outside. As illustrated in FIG. 1, the tubular portion 62 surrounds the controller 80 from radially outside. The tubular portion 62 includes an inclined part 62a and a body part 62b. The inclined part 62a extends downward and obliquely radially outward from the radially outer peripheral edge part of the top plate portion 61. The body part 62b extends downward from a radially outer peripheral edge part of the inclined part 62a. The body part 62b includes a lower end portion surrounding the first surface 26a of the stepped part 26 from radially outside. The lower end portion of the body part 62b has an inner peripheral surface fixed to the first surface 26a with an adhesive, for example.

The flange part 63 protrudes radially outward from a lower end portion of the tubular portion 62. The flange part 63 has an annular shape provided over the entire circumference of the lower end portion of the tubular portion 62. The flange part 63 is located above the second surface 26b of the stepped part 26. The flange part 63 is fixed to the second surface 26b with an adhesive, for example.

The protruding tubular portion 64 protrudes upward from the top plate portion 61. The protruding tubular portion 64 is provided in the first part 60a. The protruding tubular portion 64 according to the present example embodiment has a cylindrical shape about the center axis J and open downward. The protruding tubular portion 64 includes a lid wall part 64a and a peripheral wall part 64b. The lid wall part 64a has a disk shape about the center axis J. The peripheral wall part 64b protrudes downward from a radially outer peripheral edge part of the lid wall part 64a. The peripheral wall part 64b has a cylindrical shape about the center axis J and open downward. The peripheral wall part 64b includes a lower end portion connected to an inner peripheral edge part of the arc part 61a and an end portion of the protruding plate portion 61b on the second side (−X side) in the first direction X.

The protruding tubular portion 64 internally accommodates at least a portion of the electronic component 82. The protruding tubular portion 64 according to the present example embodiment internally accommodates upper parts of the plurality of electronic components 82. The electronic component 82 at least partially accommodated in the protruding tubular portion 64 is an electronic component 82 having a relatively large axial dimension among the electronic components 82 attached to the circuit board 81. The electronic component 82 having a relatively large axial dimension is a capacitor, for example.

The motor 100 includes a weight portion 70 fixed to the cover 60. The weight portion 70 according to the present example embodiment has a plate shape with a plate surface facing the axial direction. As illustrated in FIG. 3, the weight portion 70 has a rectangular shape having a side along the first direction X and a side along the second direction Y when viewed in the axial direction. Thus, the weight portion 70 can be easily manufactured as compared with a weight portion 70 having a circular shape or the like when viewed in the axial direction.

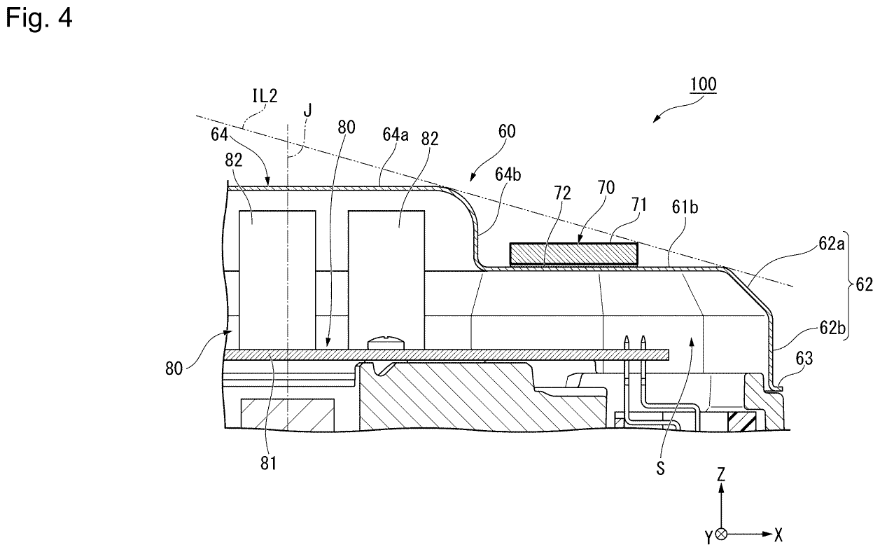

The weight portion 70 according to the present example embodiment is made of metal. The metal constituting the weight portion 70 is not particularly limited. The metal constituting the weight portion 70 is iron, lead, or copper, for example. The metal constituting the weight portion 70 may be an alloy. As illustrated in FIG. 4, the weight portion 70 according to the present example embodiment has a surface coated with a corrosion inhibitor 71. As a result, corrosion of the weight portion 70 made of metal due to rust or the like can be prevented. The corrosion inhibitor 71 may be any kind of material as long as corrosion of the weight portion 70 can be prevented, and may be a metal, a resin, or a nonmetallic inorganic substance such as glass and ceramic. The corrosion inhibitor 71 also may be coated on the surface of the weight portion 70 by any method.

The weight portion 70 according to the present example embodiment is located on an outer surface of the cover 60. The weight portion 70 is located on the protruding plate portion 61b. The weight portion 70 is fixed to an upper surface of the protruding plate portion 61b with an adhesive 72. Using the adhesive 72 enables the weight portion 70 to be suitably and easily fixed to the cover 60. Additionally, the motor 100 is likely to be reduced in weight as compared with a case where a fixing member such as a bolt is used to fix the weight portion 70.

The weight portion 70 is located on the protruding plate portion 61b on a side (−X side) close to the protruding tubular portion 64 in the first direction X. The weight portion 70 is located on the first side (+X side) in the first direction X away from the protruding tubular portion 64.

The sentence herein, “the weight portion is located on the protruding plate portion on the side closer to the protruding tubular portion in the first direction”, means that the weight portion needs to have a center position in the first direction, the center position being closer to the protruding tubular portion in the first direction than a center position of the protruding plate portion in the first direction.

As illustrated in FIG. 1, at least a portion of the weight portion 70 is located at a position protruding toward the first side (+X side) in the first direction X from the motor body 50. The weight portion 70 according to the present example embodiment includes a part on the first side in the first direction X, the part being located on the first side in the first direction X from the stator 40. The weight portion 70 includes a part on the second side (−X side) in the first direction X, the part being located at a position overlapping the stator 40 when viewed in the axial direction.

The weight portion 70 at least partially overlaps the connector 90 when viewed in the axial direction. The weight portion 70 according to the present example embodiment includes an end portion on the first side (+X side) in the first direction X, the end portion overlapping the connector 90 when viewed in the axial direction. The whole of the weight portion 70 overlaps the circuit board 81 when viewed in the axial direction, for example.

As illustrated in FIG. 3, the weight portion 70 is located in the second direction Y orthogonal to both the axial direction and the first direction X while including a center position of the cover 60 in the second direction Y. FIG. 3 illustrates the center position of the cover 60 in the second direction Y, the center position being indicated by an imaginary line IL1. The imaginary line IL1 extends in the first direction X and passes through the center of the cover 60 in the second direction Y and the center axis J when viewed in the axial direction. The weight portion 70 according to the present example embodiment has a center position in the second direction Y, the center position coinciding with the center position of the cover 60 in the second direction Y. That is, when viewed in the axial direction, the imaginary line IL1 passes through the center of the weight portion 70 in the second direction Y.

In the second direction Y orthogonal to both the axial direction and the first direction X, the weight portion 70 has a dimension L1 smaller than a dimension L2 of the protruding tubular portion 64. Thus, the weight portion 70 can be prevented from protruding in the second direction Y with respect to the protruding tubular portion 64. As a result, the weight portion 70 can be prevented from interfering with other equipment and the like. The weight portion 70 has an end portion on the first side (+Y side) in the second direction Y, the end portion being located on the second side (−Y side) in the second direction Y from an end portion of the protruding tubular portion 64 on the first side in the second direction Y. The weight portion 70 has an end portion on the second side in the second direction Y, the end portion being located on the first side in the second direction Y from an end portion of the protruding tubular portion 64 on the second side in the second direction Y. That is, the protruding tubular portion 64 protrudes toward both the sides in the second direction Y from the weight portion 70. The whole of the weight portion 70 overlaps the protruding tubular portion 64 when viewed in the first direction X.

As illustrated in FIG. 4, the weight portion 70 has an axial dimension larger than an axial dimension of the top plate portion 61, or a thickness of the top plate portion 61. The axial dimension of the weight portion 70 is smaller than an axial dimension of the protruding tubular portion 64. The weight portion 70 has an upper end portion located below an upper end portion of the protruding tubular portion 64. Thus, even when the weight portion 70 is provided, the motor 100 can be prevented from increasing in size in the axial direction. Additionally, the weight portion 70 does not protrude upward from the protruding tubular portion 64, so that the weight portion 70 can be further prevented from interfering with the other equipment and the like.

The whole of the weight portion 70 according to the present example embodiment is disposed between the imaginary line IL2 and the cover 60 when viewed in the second direction Y orthogonal to both the axial direction and the first direction X. The imaginary line IL2 connects an edge of the upper end portion of the protruding tubular portion 64, the edge being on the first side (+X side) in the first direction X, and an end portion of the protruding plate portion 61b on the first side (+X side) in the first direction X, when viewed in the second direction Y. The imaginary line IL2 extends obliquely downward toward the first side in the first direction X. The imaginary line IL2 is an imaginary straight line that is in contact with a connection part between the lid wall part 64a and the peripheral wall part 64b of the protruding tubular portion 64, and a connection part between the protruding plate portion 61b and the tubular portion 62 when viewed in the second direction Y. The whole of the weight portion 70 is located below the imaginary line IL2. The whole of the weight portion 70 is located in a region surrounded by the imaginary line IL2, the protruding tubular portion 64, and the protruding plate portion 61b when viewed in the second direction Y. When the whole of the weight portion 70 is disposed between the imaginary line IL2 and the cover 60, the whole of the weight portion 70 can be disposed behind the protruding tubular portion 64, and thus the weight portion 70 can be further prevented from interfering with the other equipment and the like.

The motor 100 according to the present example embodiment includes the weight portion 70 fixed to the cover 60. Thus, adding mass of the weight portion 70 enables a natural frequency of the cover 60 including the weight portion 70 to be changed. As a result, adjusting the mass of the weight portion 70 in accordance with a frequency of vibration of the motor body 50 enables the natural frequency of the cover 60 including the weight portion 70 to be shifted from the frequency of vibration of the motor body 50. Thus, the cover 60 can be prevented from resonating against the vibration of the motor body 50. The cover 60 accordingly can be suitably prevented from vibrating, and thus the motor 100 can be suitably prevented from generating noise.

For example, increasing rigidity of the cover 60 by bending a portion of the cover 60 also enables vibration transmitted from the motor body 50 to the cover 60 to be reduced to some extent. Unfortunately, the natural frequency of the cover 60 does not change or hardly changes in this case. Thus, analysis of the present inventors, for example, has revealed that the cover 60 cannot be prevented from resonating. When the cover 60 resonates, the vibration of the cover 60 increases in amplitude, and thus, the vibration of the cover 60 is less likely to be sufficiently prevented even with the cover 60 increased in rigidity by bending or the like as described above. In contrast, the weight portion 70 according to the present example embodiment is attached to the cover 60 as described above, so that the mass of the cover 60 including the weight portion 70 can be changed, and thus the natural frequency of the cover 60 including the weight portion 70 can be changed. As a result, the cover 60 can be suitably prevented from resonating against the vibration of the motor body 50, so that the cover 60 can be suitably prevented from vibrating.

The top plate portion 61 according to the present example embodiment includes the protruding plate portion 61b protruding from the protruding tubular portion 64 toward the first side (+X side) in the first direction X. The protruding plate portion 61b at least partially overlaps the connector 90 when viewed in the axial direction. The weight portion 70 is located on the protruding plate portion 61b. The protruding plate portion 61b protruding from the protruding tubular portion 64 to a position overlapping the connector 90 is likely to be an antinode of vibration when the cover 60 vibrates, and is likely to vibrate relatively largely in the cover 60. Thus, providing the weight portion 70 on the protruding plate portion 61b enables the natural frequency of the protruding plate portion 61b including the weight portion 70 to be suitably changed, so that the protruding plate portion 61b can be suitably prevented from vibrating due to resonance. The cover 60 accordingly can be more suitably prevented from vibrating.

The weight portion 70 according to the present example embodiment is located on the protruding plate portion 61b on the side (−X side) close to the protruding tubular portion 64 in the first direction X. This structure allows the weight portion 70 to be easily disposed close to a central part of the cover 60 in the first direction X. The central part of the cover 60 in the first direction X is particularly likely to vibrate in the cover 60. Thus, the weight portion 70 can be disposed close to the central part of the cover 60 in the first direction X, so that the cover 60 can be further prevented from vibrating. For example, analysis of the present inventors has revealed that the structure of the cover 60 according to the present example embodiment causes vibration to be likely to be particularly large at the connection part between the protruding tubular portion 64 and the protruding plate portion 61b. Thus, disposing the weight portion 70 close to the protruding tubular portion 64 enables the weight portion 70 to be disposed close to the connection part between the protruding tubular portion 64 and the protruding plate portion 61b, so that the cover 60 can be more suitably prevented from vibrating.

The weight portion 70 according to the present example embodiment is at least partially located at a position protruding toward the first side (+X side) in the first direction X from the motor body 50. This structure allows the weight portion 70 to be extended toward the first side in the first direction X, so that the weight portion 70 is likely to be increased in dimension in the first direction X to some extent. As a result, the weight portion 70 is likely to be suitably increased in mass, so that the natural frequency of the cover 60 including the weight portion 70 can be suitably changed. Additionally, the weight portion 70 is likely to be increased in area of a fixing surface to be fixed to the cover 60. Thus, the weight portion 70 is likely to be stably fixed to the cover 60.

The weight portion 70 according to the present example embodiment at least partially overlaps the connector 90 when viewed in the axial direction. This structure allows the weight portion 70 to be extended toward the first side in the first direction X, so that the weight portion 70 is likely to be increased in dimension in the first direction X to some extent. As a result, the weight portion 70 is likely to be suitably increased in mass, so that the natural frequency of the cover 60 including the weight portion 70 can be suitably changed. Additionally, the weight portion 70 is likely to be increased in area of a fixing surface to be fixed to the cover 60. Thus, the weight portion 70 is likely to be stably fixed to the cover 60.

The weight portion 70 according to the present example embodiment is located in the second direction Y orthogonal to both the axial direction and the first direction X while including the center position of the cover 60 in the second direction Y. The center of the cover 60 in the second direction Y is likely to be an antinode of vibration when the cover 60 vibrates, and thus is likely to vibrate largely. Thus, disposing the weight portion 70 at a location including the center position of the cover 60 in the second direction Y enables the cover 60 to be more suitably prevented from vibrating.

The weight portion 70 according to the present example embodiment is fixed to the upper surface of the protruding plate portion 61b. Thus, the weight portion 70 is not disposed in the accommodation space S between the cover 60 and the housing 20. This structure enables the accommodation space S to be prevented from being narrowed as compared with when the weight portion 70 is disposed in the accommodation space S, and thus enables the controller 80 to be suitably disposed in the accommodation space S. Additionally, the weight portion 70 can be fixed from the outside of the cover 60 to facilitate fixing of the weight portion 70. Even when the weight portion 70 is located at a location exposed to the outside of the motor 100 as described above, corrosion of the weight portion 70 can be prevented by coating the surface of the weight portion 70 with the corrosion inhibitor 71 as described above.

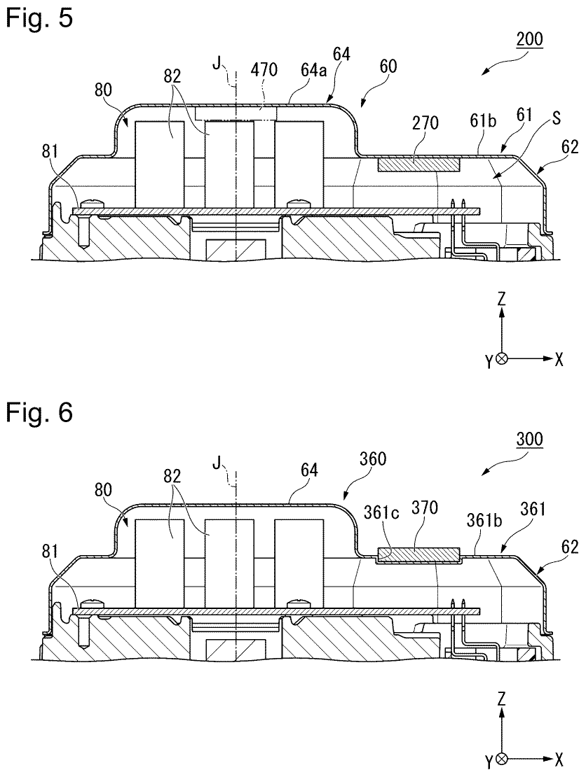

Description below may not describe components as in the above-described example embodiment by denoting the same reference numerals as appropriate, for example. As illustrated in FIG. 5, a motor 200 of the present example embodiment includes a weight portion 270 that is located on an inner surface of a cover 60. Thus, the weight portion 270 does not protrude to the outside of the motor 200, so that the motor 200 can be prevented from increasing in size.

The weight portion 270 according to the present example embodiment is fixed to a lower surface of a protruding plate portion 61b. The weight portion 270 is disposed above a circuit board 81 with an interval while facing the circuit board 81 in an accommodation space S. The weight portion 270 is similar in other structures to the weight portion 70 of the first example embodiment. The motor 200 is similar in other structures to the motor 100 of the first example embodiment.

Description below may not describe components as in the above-described example embodiment by denoting the same reference numerals as appropriate, for example. As illustrated in FIG. 6, a cover 360 of a motor 300 of the present example embodiment includes a top plate portion 361 including a protruding plate portion 361b with a recess 361c recessed in the axial direction. The recess 361c is formed by recessing a portion of the protruding plate portion 361b downward by press working or the like. Although not illustrated, the recess 361c is similar in shape viewed in the axial direction to a weight portion 370.

The weight portion 370 according to the present example embodiment is fitted in the recess 361c. This structure facilitates positioning of the weight portion 370 with respect to the cover 360 when the weight portion 370 is attached. Providing the recess 361c also enables the protruding plate portion 361b to be increased in rigidity. Thus, the cover 360 can be further prevented from vibrating. The weight portion 370 according to the present example embodiment includes a lower part fitted into the recess 361c from the upper side. The weight portion 370 has a lower surface fixed to a bottom surface of the recess 361c with an adhesive, for example.

The cover 360 is similar in other structures to the cover 60 of the first example embodiment. The weight portion 370 is similar in other structures to the weight portion 70 of the first example embodiment. The motor 300 is similar in other structures to the motor 100 of the first example embodiment.

The present disclosure is not limited to the above-described example embodiments, and other structures and other methods can be employed within the scope of the technical idea of the present disclosure. The material constituting the weight portion is not particularly limited. The material constituting the weight portion may be a material other than metal. The weight portion is not particularly limited in shape. The weight portion may have a columnar shape or a polygonal prismatic shape other than a quadrangular prismatic shape, for example. The weight portion may have a surface that is not coated with a corrosion inhibitor. When the weight portion is made of metal, the weight portion may have a surface that is subjected to treatment of preventing electrolytic corrosion. Even in this case, corrosion of the weight portion can be prevented. A method for fixing the weight portion to the cover is not particularly limited. The weight portion may be fixed to the cover using a fixing member such as a bolt, or may be fixed to the cover by caulking a portion of the cover.

The weight portion may be fixed to any position of the cover. The weight portion may be fixed to the protruding tubular portion 64 as with a weight portion 170 indicated by a two-dot chain line in FIG. 1 and a weight portion 470 indicated by a two-dot chain line in FIG. 5. As illustrated in FIG. 1, the weight portion 170 is fixed to an upper surface of the lid wall part 64a of the protruding tubular portion 64. That is, the weight portion 170 is fixed to the outer surface of the cover 60. As illustrated in FIG. 5, the weight portion 470 is fixed to a lower surface of the lid wall part 64a. That is, the weight portion 470 is fixed to the inner surface of the cover 60.

A plurality of weight portions may be provided. In this case, two or more appropriate weight portions among the above-described weight portions may be provided. For example, both the weight portion 70 and the weight portion 170 illustrated in FIG. 1 may be provided. When the weight portion 70 has a mass set to be suitable for preventing resonance of the protruding plate portion 61b, and the weight portion 170 has a mass set to be suitable for preventing resonance of the lid wall part 64a in this case, the resonance of the protruding plate portion 61b and the lid wall part 64a can be suitably prevented. The cover 60 accordingly can be more suitably prevented from vibrating.

The application of the motor to which the present disclosure is applied is not particularly limited. The motor may be mounted on, for example, a vehicle or a device other than the vehicle. The structures described above in the present description may be appropriately combined in a range where no conflict arises.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-14. (canceled)

15: A motor comprising:
a motor body including a rotor rotatable about a center axis extending in an axial direction and a stator opposing the rotor with a gap interposed between the rotor and the stator;
a housing accommodating the motor body;
a cover covering the housing from a first side in the axial direction;
a controller including an electronic component and accommodated between the housing and the cover; and
a weight fixed to the cover.

16: The motor according to claim 15, further comprising:
a connector located at a position protruding toward a first side in a first direction perpendicular or substantially perpendicular to the axial direction from the motor body; wherein
the cover includes:
a top plate portion located on a first side in the axial direction from the controller; and
a protruding tubular portion that protrudes from the top plate portion toward the first side in the axial direction and internally accommodates at least a portion of the electronic component;
the top plate portion includes a protruding plate portion that protrudes from the protruding tubular portion toward the first side in the first direction;
at least a portion of the protruding plate portion overlaps the connector when viewed in the axial direction; and
the weight is located on the protruding plate portion.

17: The motor according to claim 16, wherein the weight is located on the protruding plate portion on a side adjacent to the protruding tubular portion in the first direction.

18: The motor according to claim 16, wherein at least a portion of the weight is located at a position protruding toward the first side in the first direction from the motor body.

19: The motor according to claim 16, wherein at least a portion of the weight overlaps the connector when viewed in the axial direction.

20: The motor according to claim 16, wherein a position of the weight in a second direction, which is perpendicular or substantially perpendicular to both the axial direction and the first direction, includes a center position of the cover in the second direction.

21: The motor according to claim 16, wherein
the protruding plate portion includes a recess recessed in the axial direction; and
the weight is fitted in the recess.

22: The motor according to claim 16, wherein
the weight is fixed to a surface of the protruding plate portion, the surface being on the first side in the axial direction.

23: The motor according to claim 22, wherein
the weight has a dimension in the second direction perpendicular or substantially perpendicular to both the axial direction and the first direction, the dimension being smaller than a dimension of the protruding tubular portion in the second direction.

24: The motor according to claim 22, wherein an end portion of the weight on the first side in the axial direction is located on a second side in the axial direction from an end portion of the protruding tubular portion on the first side in the axial direction.

25: The motor according to claim 22, wherein
an entirety of the weight is located between the cover and an imaginary line when viewed in a second direction perpendicular or substantially perpendicular to both the axial direction and the first direction, the imaginary line connecting an edge of an end portion of the protruding tubular portion on the first side in the axial direction, the edge being on the first side in the first direction, and an end portion of the protruding plate portion on the first side in the first direction.

26: The motor according to claim 15, wherein the weight is located on an inner surface of the cover.

27: The motor according to claim 15, wherein the weight is fixed with an adhesive.

28: The motor according to claim 15, wherein
the weight is made of metal; and
the weight includes a surface coated with a corrosion inhibitor.
